(19) United States
(12) Patent Application Publication
(10) Pub. No.: US 2005/0059355 A1
(43) Pub. Date: Mar. 17, 2005

(54) System and method for multi-path simulation

(75) Inventor: I-Ru Liu, Taipei (TW)

Correspondence Address: BRUCE H. TROXELL;TROXELL LAW OFFICE PLLC, SUITE 1404, 5205 LEESBURG PIKE, FALLS CHURCH, VA, 22041, US

(73) Assignee: Accton Technology Corporation

(21) Appl. No.: 10/663,664

(22) Filed: Sep. 17, 2003

(51) Int. Cl. H04B 17/00

(52) U.S. Cl. 455/67.14

(57) ABSTRACT

The present invention provides a system and method for multi-path simulation that employs a shielded anechoic chamber to avoid external electromagnetic interference and other uncontrollable transmission paths during testing, and simulates a main indirect transmission path by a reflector within the chamber. An attenuating device is used to attenuate signals, thereby simulating the signal attenuation during transmission. The shielded anechoic chamber also includes a movable platform and a turntable, both controlled by a control unit, for carrying a dipole antenna and a wireless communication device to be tested respectively. The movable platform is used to shift the antenna, thereby simulating the phase shift between a direct path and a main indirect path of the system; the turntable is used to change the reception azimuth of the communication device, thereby measuring the performance of the device in various azimuth angles.

### BACKGROUND OF THE INVENTION

(a). Field of the Invention

The present invention relates in general to multi-path simulation, and more particularly to a system and method that employs a shielded anechoic chamber for avoiding external electromagnetic interference (EMI), a reflector thereof for simulating the main indirect path of a signal; and an attenuating device for simulating the signal attenuation during transmission.
(b). Description of the Prior Arts

In recent years, cellular phones and wireless local area networks (WLAN) are in widespread use with the rapid development of wireless communication technologies. In comparison with the signal transmission with a single physical path, the wireless signal transmission has an intrinsic multi-path phenomenon. The multi-path phenomenon means the wireless signal reaching the receiving antenna by two or more paths. The phenomenon results in the constructive or destructive interference, and phase shifting of the signal, caused by the refraction, and the reflection from objects, such as buildings and obstacles. Especially, the destructive interference resulted from the superposition of the phase of different paths may cause deep fades on signals. The phenomenon exists in most real environments and would increase the complexity and instability of signal

In a multi-path environment, it usually exists a direct path and numerous indirect paths. A direct path means a path that goes from the transmission side to the reception side without incurring any reflection, while an indirect path means a path that goes from the transmission side to the reception side with incurring at least one reflection. Compared to the direct path, the indirect path would cause larger signal attenuation. Although there may be many different indirect paths, it is reasonable to select the indirect path with the least attenuation for representation and to neglect others of little significance. In this specification, the selected indirect path is called a main indirect path.

The conventional approach applies the architecture shown in FIG. 1 to simulate the wireless communication space with a direct path and a main indirect path. The architecture of FIG. 1 is located in an open space, such as the outdoors. The architecture includes a signal generator 11 for generating a testing signal; an antenna 12, coupled to the signal generator 11 for transmitting the testing signal; a reflector 13 located behind the antenna 12 for reflecting the testing signal to generate a reflected signal; and a device 14 to be tested for receiving the testing signal and the reflected signal. The path going directly from the antenna 12 to the device 14 is the direct path, while the path going from the antenna 12 via the reflector 13 to the device 14 is the main indirect path.

However, there are two major drawbacks in the architecture of FIG. 1: (1) The architecture needs to deploy in an ideal open space, thus it is very difficult in reality to avoid external EMI and unnecessary reflection paths. (2) It is necessary to change the position of the device 14 to meet the required distance of signal transmission. This would bring space limits for practical operation. In view of this, the present invention provides a system and method for multi-path simulation that can avoid external EMI and superfluous reflection paths and operate without the limits of space for testing.

### SUMMARY OF THE INVENTION

The present invention employs a shielded anechoic chamber to avoid external electromagnetic interference and other uncontrollable transmission paths during testing. The internal walls of the chamber are composed of particular material for absorbing most energy of the signal penetrating the internal walls and reducing the strength of the reflected signal significantly. A reflector within the chamber can be used to simulate the main indirect transmission path. The present invention also employs an attenuating device to attenuate transmitted signals, thereby simulating the signal attenuation during transmission. Thus, the real electromagnetic environment can be simulated without limits of the chamber size, and various radio experiments and measurements may be performed within the simulated environment to obtain reliable results.

Accordingly, the primary object of the present invention is to provide a system for multi-path simulation, which comprises: a signal generator for generating a signal; an attenuating device coupled to the signal generator for attenuating the signal and generating an attenuated signal to simulate the signal attenuation during transmission; and a shielded anechoic chamber. The shielded anechoic chamber contains an antenna coupled to the attenuating device for transmitting the attenuated signal, wherein the position of the antenna can be adjusted to simulate a phase shift between a direct path and a main indirect path of the system. The chamber also contains a reflector for reflecting the attenuated signal to generate a reflected signal.

The secondary object of the present invention is to provide a method for multi-path simulation, which comprises: generating a signal; attenuating the signal to generate an attenuated signal for simulating the signal attenuation during transmission; transmitting the attenuated signal by an antenna, wherein the antenna is located in a shielded anechoic chamber with a reflector, and the reflector reflects the attenuated signal to generate a reflected signal; and receiving the attenuated signal and the reflected signal by a communication device within the shielded anechoic chamber.

The third object of the present invention is to provide a method for measuring the diversity gain of a communication device. The communication device switches between a single antenna mode and an antenna diversity mode and is located within a shielded anechoic chamber. The method comprising steps of: a. configuring the communication device to the single antenna mode; b. generating a signal; c. attenuating the testing signal by a first attenuation setting; d. transmitting the attenuated testing signal by an antenna within the shielded anechoic chamber, wherein the chamber includes a reflector for reflecting the attenuated testing signal to generate a reflected signal; e. receiving the attenuated testing signal and the reflected signal by the communication device; f. measuring a signal parameter received by the communication device to acquire a reference value; g. switching the communication device to the antenna diversity mode and repeating the steps b to e; h. attenuating the testing signal by a second attenuation setting to make the signal parameter equal to the reference value; and i. calculating the difference between the first and second attenuation settings, wherein the difference is the diversity gain of the communication device.

### BRIEF DESCRIPTION OF THE DRAWINGS

FIG. 1 is a block diagram showing a conventional system for multi-path simulation.

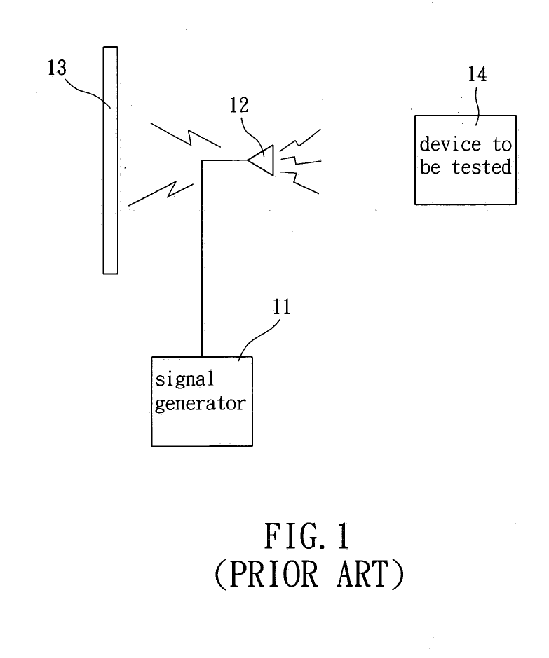

FIG. 2 is a block diagram showing a preferred embodiment of the system for multi-path simulation according to the present invention.

FIG. 3 is a flow chart showing a preferred embodiment of the method for multi-path simulation according to the present invention.

FIG. 4 is a flow chart of the application for measuring the antenna diversity gain by using the system of the present invention.

### DETAILED DESCRIPTION OF THE PRESENT INVENTION

communication device.

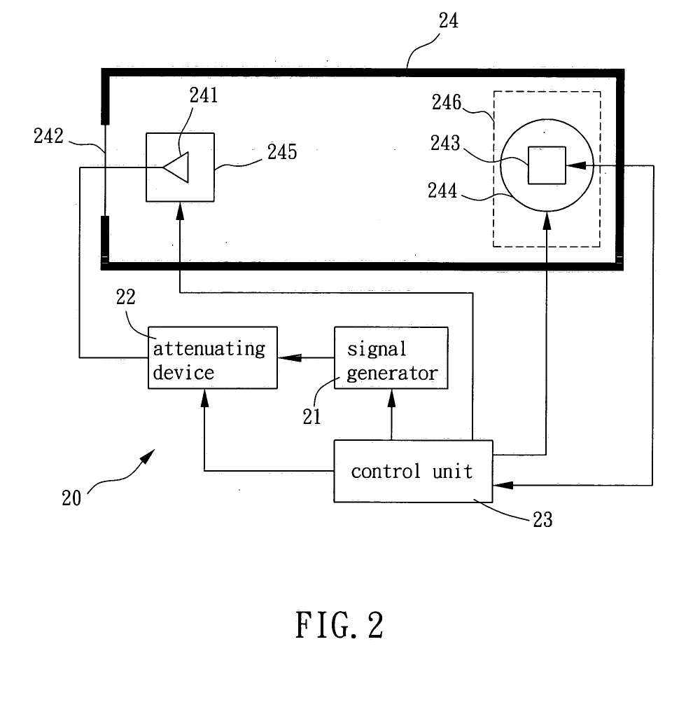

FIG. 2 is a block diagram showing a preferred embodiment of the system for multi-path simulation according to the present invention. As mentioned above, the system for multi-path simulation is used to simulate a wireless communication space with a direct transmission path and a main indirect transmission path. As shown in FIG. 2, the system 20 for multi-path simulation includes a signal generator 21 for generating a signal and an attenuating device 22 coupled to the signal generator 21 for attenuating the signal and generating an attenuated signal to simulate the signal attenuation during transmission. The system 20 also includes a control unit 23 coupled to the signal generator 21 and the attenuating device 22 for controlling signal generation of the signal generator 21 and adjusting an attenuation setting of the attenuating device 22. The system 20 also includes a shielded anechoic chamber 24, which is used to isolate external EMI and lower the reflection effects resulted from the propagation of the attenuated signal within the chamber 24.

The shielded anechoic chamber 24 contains a dipole antenna 241 coupled to the attenuating device 22 and used to transmit the attenuated signal. The dipole antenna 241 is omnidirectional, and its position can be adjusted to simulate a phase shift between a direct path and a main indirect path of the system 20. The shielded anechoic chamber 24 also contains a reflector 242, such as a flat plane reflector, for reflecting the attenuated signal to generate a reflected signal. The reflector 242, depicted by a thin line in FIG. 2, is composed of the material different from that of other internal walls (depicted by bold lines in FIG. 2) of the chamber 24. The chamber 24 also contains a communication device 243 for receiving the attenuated signal and the reflected signal.

As shown in FIG. 2, the direct path of the system 20 goes from the input of the attenuating device 22, via the attenuating device 22, the chamber 24, and the dipole antenna 241, to the communication device 243 without any reflection. The main indirect path is different from the direct path in that when a signal is transmitted by the dipole antenna 241, it is reflected by the reflector 242 (the dipole antenna 241 is located between the reflector 242 and the communication device 243) and then transmitted to the communication device 243.

To obtain better simulation results, the system 20 adopts a Golden Sample of the communication device 243 as the signal generator 21. The Golden Sample conforms to associated standards and specifications much closer than the communication device 243, thus its signal quality is better for testing. Besides, a vector signal generator, combined with a power amplifier occasionally, can also be used as the signal generator 21 to generate signals more accurately and variously.

In addition, a step attenuator may be used as the attenuating device 22. The attenuation setting of the step attenuator can be stepwise adjusted by the control unit 23 for simulating the attenuation of signals of the generator 21 during transmission in a communication space. The larger attenuation setting simulates a longer distance of the signal transmission.

The shielded anechoic chamber 24 also contains a turntable 244 for carrying the communication device 243 and changing the reception azimuth of the communication device 243. The reception azimuth influences the features of signal reception of the communication device 243, such as antenna diversity effects, radiation patterns, etc., thus these features at different azimuths can be measured by rotating the turntable 244.

The shielded anechoic chamber 24 also contains a movable platform 245 for setting the dipole antenna 241. The movable platform 245 can be shifted forward or backward against the communication device 243 to adjust the position of the antenna 241. Since the position of the antenna 241 has relations with the lengths of the direct path and the main indirect path of the system 20 and thus with the phases of the signals propagated in these two paths, the phase shift between the two paths can be simulated by proper adjustments. It is notable that by means of the calibration of the system 20, we can know both the correspondence between the phase shift and the displacement of the platform 245, and the correspondence between the transmission distance and the attenuation setting (commonly represented by dB) of the attenuating device 22.

The shielded anechoic chamber 24 also contains a quiet zone 246 where the communication device 243 is located. Within the quiet zone 246, which is formed due to the characteristics of the chamber 24, the signals transmitted in all paths except the direct path and the main indirect path would be lowered significantly. Therefore, better simulation results can be acquired by locating the communication device 243 in the quiet zone 246.

Please refer to FIG. 2 again. The control unit 23 is also coupled to the turntable 244 and the movable platform 245, thereby controlling the rotation angle of the turntable 244 and the displacement of the platform 245 respectively. The control unit 23 is also coupled to the communication device 243, thereby acquiring signal properties of the communication device 243. Here the signal properties may include signal strength, signal qualify, frame error rate, throughput, etc. Accordingly, the control unit 23 can rotate the turntable 244 to measure the radiation patterns, move the platform 245 to simulate the phase shift between the direct path and the indirect path, and acquire the signal properties for further analysis, in addition to controlling the signal generation and the signal attenuation setting.

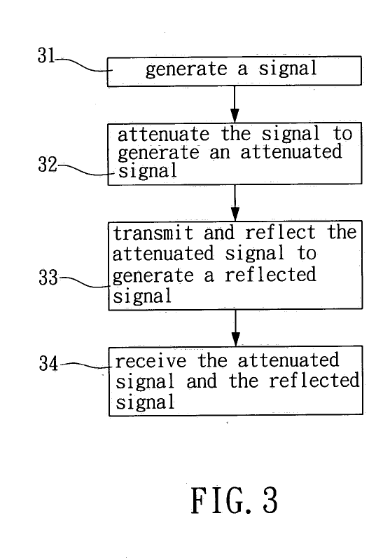

Next, it would be explained how to utilize the system 20 to implement the method for multi-path simulation according to the present invention. FIG. 3 is a flow chart showing a preferred embodiment of the method for multi-path simulation according to the present invention. As shown in FIG. 3, the flow chart comprises steps of:
31 generating a signal by the signal generator 21;
32 attenuating the signal by the attenuating device 22 to generate an attenuated signal for simulating attenuation generated in the transmission of the signal;
33 transmitting the attenuated signal by the dipole antenna 241 and reflecting the attenuated signal by the reflector 242 to generate a reflected signal; and
34 receiving the attenuated signal and the reflected signal by the communication device 243.

In the step 33, the position of the dipole antenna 241 can be adjusted by the control unit 23 to change the phase shift between the direct path and the main indirect path of the system 20, i.e. the phase shift between the attenuated signal and the reflected signal received by the communication device 243.

In the step 34, the turntable 244 may be rotated by the control unit 23 to change the reception azimuth of the communication device 243.

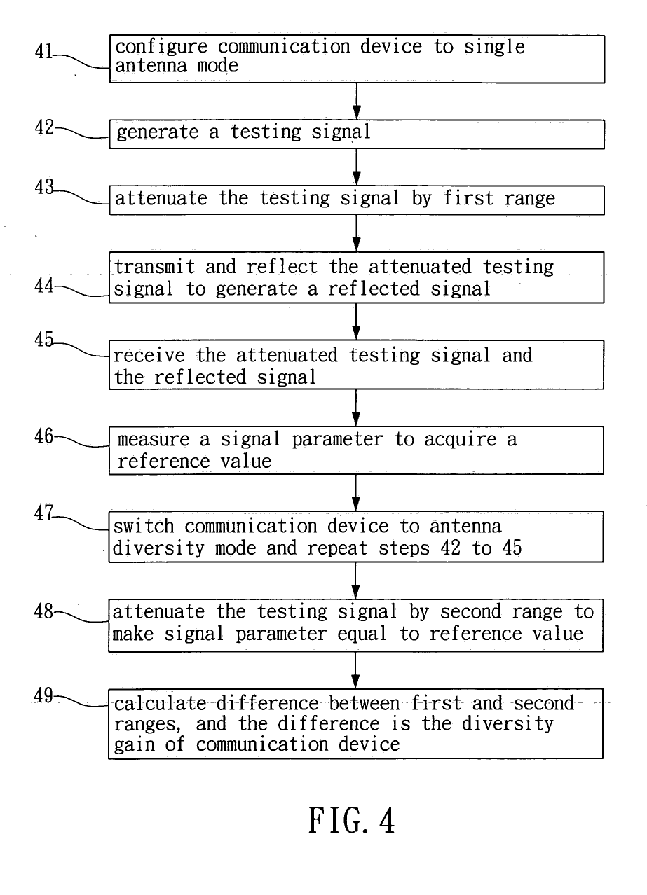

By utilizing the system 20 for multi-path simulation, we can test a wireless communication device for reception of various signals. Next, a detailed description is provided to explain the application for measuring the diversity gain of a wireless communication device by using the system 20. Here the communication device 243 of the system 20 can be switched between a single antenna mode and an antenna diversity mode. FIG. 4 is a flow chart of the application for measuring the antenna diversity gain by using the system 20. As shown in FIG. 4, the flow comprises the following steps:
41 setting the communication device 243 by the control unit 23 to the single antenna mode;
42 generating a testing signal by the signal generator 21;
43 attenuating the testing signal by a first attenuation setting by the attenuating device 22;
44 transmitting the attenuated testing signal by the dipole antenna 241, and reflecting the attenuated testing signal by the reflector 242 to generate a reflected signal;
45 receiving the attenuated testing signal and the reflected signal by the communication device 243;
46 measuring a signal parameter received by the communication device 243 by the control unit 23 to acquire a reference value;
47 switching the communication device 243 to the antenna diversity mode by the control unit 23 and repeating the steps 42 to 45;
48 attenuating the testing signal by a second attenuation setting to make the signal parameter equal to the reference value; and
49 calculating the difference between the first and second attenuation settings, wherein the difference is the diversity gain of the communication device 243.

The position of the dipole antenna 241 can be shifted by the control unit 23 to change the phase shift between a direct transmission path and a main indirect transmission path of the attenuated testing signal. The influence of this phase shift on the diversity gain can be known by repeating the steps 41 to 49 for different phase shifts.

Similarly, the turntable 244 may be rotated by the control unit 23 to change the reception azimuth of the communication device 243. The influence of this reception azimuth on the diversity gain can be known by repeating the steps 41 to 49 for different reception azimuths.

Besides, the signal parameter mentioned above can be signal strength, a signal quality parameter or throughput.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

1. A system for multi-path simulation comprising:
a signal generator for generating a signal;
an attenuating device coupled to the signal generator for attenuating the signal and generating an attenuated signal to simulate an attenuation resulting from a transmission of the signal; and
a shielded anechoic chamber comprising:
an antenna coupled to the attenuating device for transmitting the attenuated signal, wherein the antenna can be shifted to simulate a phase shift between a direct path and a main indirect path of the system; and
a reflector for reflecting the attenuated signal to generate a reflected signal.

2. The system of claim 1, wherein the shielded anechoic chamber further comprises:
a communication device for receiving the attenuated signal and the reflected signal.

3. The system of claim 1, wherein the signal generator is a vector signal generator.

4. The system of claim 2, wherein the signal generator is a Golden Sample of the communication device.

5. The system of claim 1, wherein the attenuating device is a step attenuator.

6. The system of claim 1, wherein the antenna is a dipole antenna.

7. The system of claim 2, wherein the antenna is deployed between the reflector and the communication device.

8. The system of claim 1, further comprising:
a control unit coupled to the signal generator and the attenuating device for controlling a generation of the signal and adjusting an attenuating range of the attenuating device.

9. The system of claim 2, further comprising:
a control unit coupled to the communication device for acquiring signal properties received by the communication device.

10. The system of claim 2, wherein the shielded anechoic chamber further comprises:
a turntable for setting the communication device and changing a reception azimuth of the communication device.

11. The system of claim 2, wherein the shielded anechoic chamber further comprises:
a movable platform for setting and shifting the antenna.

12. The system of claim 2, wherein the communication device is deployed in a quiet zone of the shielded anechoic chamber.

13. A method for multi-path simulation comprising:
generating a signal;
attenuating the signal to generate an attenuated signal for simulating an attenuation resulting from a transmission of the signal;
transmitting the attenuated signal by an antenna, wherein the antenna is deployed in a shielded anechoic chamber with a reflector, and the reflector reflects the attenuated signal to generate a reflected signal; and
receiving the attenuated signal and the reflected signal by a communication device deployed within the shielded anechoic chamber.

14. The method of claim 13, wherein the signal is generated by a vector signal generator.

15. The method of claim 13, wherein the signal is generated by a Golden Sample of the communication device.

16. The method of claim 13, wherein the signal is attenuated by a step attenuator.

17. The method of claim 13, wherein the antenna is deployed between the reflector and the communication device.

18. The method of claim 13, further comprising:
shifting the antenna to simulate a phase shift between a direct transmission path and a main indirect transmission path of the signal.

19. The method of claim 13, wherein the communication device is set on a turntable, and the method further comprising:
rotating the turntable to change a reception azimuth of the communication device.

20. The method of claim 13, wherein the communication device is deployed in a quiet zone of the shielded anechoic chamber.

21. A method for measuring a diversity gain of a communication device, the communication device switching between a single antenna mode and an antenna diversity mode and deployed within a shielded anechoic chamber, the method comprising steps of:
a. setting the communication device to the single antenna mode;
b. generating a testing signal;
c. attenuating the testing signal by a first attenuation setting;
d. transmitting the attenuated testing signal by an antenna within the shielded anechoic chamber, wherein the shielded anechoic chamber includes a reflector for reflecting the attenuated testing signal to generate a reflected signal;
e. receiving the attenuated testing signal and the reflected signal by the communication device;
f. measuring a signal parameter received by the communication device to acquire a reference value;
g. switching the communication device to the antenna diversity mode and repeating the steps b to e;
h. attenuating the testing signal by a second attenuation setting to make the signal parameter equal to the reference value; and
i. calculating a difference between the first and second attenuation settings, wherein the difference is the diversity gain of the communication device.

22. The method of claim 21, wherein the communication device is deployed in a quiet zone of the shielded anechoic chamber.

23. The method of claim 21, wherein the antenna is deployed between the reflector and the communication device.

24. The method of claim 21, wherein the testing signal is generated by a vector signal generator in the step b.

25. The method of claim 21, wherein the testing signal is generated by a Golden Sample of the communication device in the step b.

26. The method of claim 21, wherein the testing signal is attenuated by a step attenuator in the steps c and h.

27. The method of claim 21, further comprising:
j. shifting the antenna to change a phase shift between a direct transmission path and a main indirect transmission path of the attenuated testing signal, and repeating the steps a to i.

28. The method of claim 21, wherein the communication device is set on a turntable, the method further comprising:
k. rotating the turntable to change a reception azimuth of the communication device, and repeating the steps a to i.

29. The method of claim 21, wherein the signal parameter is selected from a group consisting of signal strength, a signal quality parameter and throughput.
